(19) United States
(12) Patent Application Publication
(10) Pub. No.: US 2010/0275777 A1
(43) Pub. Date: Nov. 4, 2010

(54) Membrane-Based Process for CO2 Capture from Flue Gases Generated by Oxy-Combustion of Coal

(76) Inventors: David J. HASSE, Bel Air, MD (US); Rajeev S. PRABHAKAR, Wilmington, DE (US)

Correspondence Address: AIR LIQUIDE USA LLC;Intellectual Property, 2700 POST OAK BOULEVARD, SUITE 1800, HOUSTON, TX, 77056, US

(21) Appl. No.: 12/433,695

(22) Filed: Apr. 30, 2009

(51) Int. Cl. B01D 53/22

(52) U.S. Cl. 95/51; 96/9

(57) ABSTRACT

Disclosed is a membrane-based method and system for treatment of flue gases from an oxy-combustion coal-fired boiler to recover approximately 90% (vol/vol) to approximately 95% (vol/vol) of the carbon dioxide in the flue gas and produce a carbon dioxide product having a carbon dioxide concentration of approximately 90% (vol/vol dry basis) to approximately 97% (vol/vol dry basis).

### BACKGROUND

Coal is often used as an energy source for industrial processes such as power generation. Coal combustion produces CO₂, a greenhouse gas. Concerns of global warming have prompted calls for reduction in CO₂ emissions. Processes have been proposed to extract CO₂ from the flue gases of industrial processes and sequester the CO₂ in the ground, thus preventing this greenhouse gas from being released into the atmosphere.

The US Department of Energy (DOE) currently defines a “clean coal” power plant as one that captures at least 90% of the CO₂ generated by the power plant. The captured CO₂ stream must be at a desired purity, temperature, and pressure in order to be suitable for transportation and storage. The CO₂ stream may also be used for enhanced oil recovery, enhanced gas recovery, or other applications, such as storage or sequestration. However, these applications may impose additional specifications on the CO₂ stream.

If coal is combusted in air, the flue gas contains about 12-20% CO₂ (vol/vol dry basis), with the majority of the remaining gas being N₂. Acidic gases like oxides of sulfur (SOₓ) and nitrogen (NOₓ) are also present in the flue gas. Conventional processes like amine absorption have been utilized to extract CO₂ from such flue gases. However, amine systems cannot tolerate sulfur compounds, thus requiring a sulfur removal system. The extent of sulfur removal prior to amine processing may be more than mandated by transport or storage specifications of CO₂-containing streams, thus increasing the overall cost of the CO₂ capture unit. Amine units also have a large footprint which further increases the cost of these systems. Finally, amine systems lose a portion of amine in the effluent gas stream, thus requiring make-up amine. More importantly, amine vapors are a hazardous waste, thus causing pollution or requiring additional treatment processes for amine capture.

Membrane-based processes have been proposed for CO₂ capture from coal combustion in air. However, these processes are not economical for processing dilute streams of CO₂. The large volume of the flue gas stream requires a great deal of compression energy to compress the stream to high pressures for membrane separation and a large amount of membrane area to separate the components of the gas.

Oxy-coal combustion has been proposed as an option to simplify the CO₂ purification process by removing N₂ from air before the combustion process. Oxygen having a relatively high concentration may be used instead of using air as the oxidant in the combustion of coal. This results in a flue gas stream that is highly concentrated in CO₂. Additionally, the flue gas volume decreases significantly. Some exemplary flue gas components produced by the oxy-coal combustion process, based on the type of coal, follow:

Estimated Flue Gas Compositions For Pulverized
Coal Oxy-Fired Power Plant

| | | | Sub- | | Eastern | |
|---|---|---|---|---|---|---|
| | Lignite | | Bituminous | | Bituminous | |
| | weight | | weight | | weight | |
| Constituents | % | mol % | % | mol % | % | mol % |
| H₂O | 8.61 | 17.41 | 8.64 | 17.42 | 8.70 | 17.43 |
| CO₂ | 72.08 | 59.63 | 72.20 | 59.57 | 70.96 | 58.18 |
| N₂ | 12.32 | 16.01 | 12.59 | 16.32 | 13.68 | 17.63 |
| O₂ | 3.60 | 4.10 | 3.53 | 4.00 | 3.64 | 4.11 |
| SO₂ | 0.67 | 0.38 | 0.24 | 0.14 | 0.18 | 0.10 |
| Ar | 2.63 | 2.40 | 2.75 | 2.50 | 2.77 | 2.50 |

Cryogenic processes have been proposed to purify the flue gas produced by the oxy-coal combustion process, while still capturing enough CO₂ to meet clean coal requirements. This overall process is economically competitive with amine scrubbing. However, cryogenic processes require removal of water vapor from the flue gas stream to prevent water condensation/freezing at cryogenic temperatures. These water vapor removal requirements are stricter than current specifications on water content for pipeline transport of CO₂. For example, the widely recognized Kinder Morgan specification limits water content in CO₂ pipelines to 30 lb/MMCF (pounds/million cubic feet) or ˜600 ppmv (parts per million volume), while cryogenic systems require water removal below 10 ppmv. This introduces additional costs to the purification process.

Also, cryogenic processes are limited in the combinations of CO₂ purity and recovery combinations that they can provide because the process relies upon the vapor-liquid equilibrium phenomena to separate mixtures. Therefore, cryogenic processes offer little availability to change operating conditions and/or compression costs.

Thus, there is a need for a system and process to capture CO₂ in desirable and adjustable purity-recovery combinations at low cost and that are flexible to the changing conditions, such as flue gas compositions and volumes, in the oxy-coal combustion process.

### SUMMARY

Disclosed is a method of purifying carbon dioxide from a gaseous mixture by obtaining a gaseous mixture from a flue gas of an oxy-coal combustion process at a low pressure. The gaseous mixture is compressed by a first compressor train and flowed into a gas separation membrane system having two or more stages, each stage selectively permeating a carbon dioxide enriched stream. The gas separation membrane system recovering approximately 90% (vol/vol) to approximately 95% (vol/vol) of the carbon dioxide from the gaseous mixture and produces a carbon dioxide product having a carbon dioxide concentration of approximately 90% (vol/vol dry basis) to approximately 97% (vol/vol dry basis).

Embodiments of the method may further include one or more of the following aspects:
the gaseous mixture is at a pressure of approximately 0.8 to 1.2 bar.
the gaseous mixture comprises greater than approximately 65% (vol/vol dry basis) carbon dioxide.
the first compressor train compresses the gaseous mixture to a pressure of approximately 3 to approximately 30 bar.
the gas separation membrane system having two stages, with the compressed gaseous mixture flowing into the first stage to produce a first retentate and the carbon dioxide product as a first permeate; the first retentate flowing into the second stage to produce a second permeate and a second retentate; the second retentate is vented to atmosphere; and the second permeate is directed to the first compressor train for combination with the gaseous mixture.
the gas separation membrane system having three stages and a second compressor train, with the compressed gaseous mixture flowing into the first stage to produce a first permeate and a first retentate; the first retentate flowing into the second stage to produce a second permeate and a second retentate; the second retentate being vented to atmosphere and the second permeate flowing into the second compressor train; the compressed second permeate flowing into the third stage to produce a third retentate and a third permeate; the third retentate being combined with the first retentate at the second stage to produce the second permeate and the second retentate; and the third permeate being combined with the first permeate to produce the carbon dioxide product.

Also disclosed is a carbon dioxide purification system for recovering carbon dioxide from a source of low pressure gaseous mixtures obtained from the flue gas of an oxy-coal combustion process. The gaseous mixture contains greater than approximately 65% (vol/vol dry basis) carbon dioxide and is at a pressure of approximately 0.8 to 1.2 bar. A first compressor train compresses the gaseous mixture and a gas separation membrane unit receives the compressed gaseous mixture from the first compressor train. The gas separation membrane unit has two or more stages, each stage selectively permeating a carbon dioxide enriched stream. The gas separation membrane unit recovers approximately 90% (vol/vol) to approximately 95% (vol/vol) of the carbon dioxide in the gaseous mixture and produces a carbon dioxide product having a carbon dioxide concentration of approximately 90% (vol/vol dry basis) to approximately 97% (vol/vol dry basis).

Embodiments of the method may further include one or more of the following:
the gas separation membrane unit having two stages, a first stage adapted to separate the compressed gaseous mixture into a first retentate and the carbon dioxide product as a first permeate, a second stage adapted to separate the first retentate into a second permeate and a second retentate, the second stage having a retentate outlet in selective communication with ambient to vent the second retentate to atmosphere, the second stage having a permeate outlet in fluid communication with the first compressor train, and the first compressor train being further adapted to receive a combination of the gaseous mixture and the second stage permeate.
A second compressor train, the gas separation membrane unit having three stages, a first stage adapted to separate the compressed gaseous mixture into a first permeate and a first retentate; a second stage adapted to separate the first retentate into a second permeate and a second retentate; the second stage having a retentate outlet in selective fluid communication with ambient to vent the second retentate to atmosphere; the second compressor train adapted to receive the second permeate; a third stage adapted to separate the compressed second permeate into a third retentate and a third permeate; the second stage having an inlet in fluid communication with a retenate outlet of the third stage for combination of the third retentate and the first retentate; and a product line in fluid communication with a permeate outlet of the first stage and a permeate outlet of the third stage for combination of the third permeate and the first permeate to produce the carbon dioxide product.

### BRIEF DESCRIPTION OF THE DRAWINGS

For a further understanding of the nature and objects of the present invention, reference should be made to the following detailed description, taken in conjunction with the accompanying drawings, in which like elements are given the same or analogous reference numbers and wherein:

FIG. 1 illustrates a schematic of an exemplary embodiment of the system disclosed.

FIG. 2 illustrates a schematic of another exemplary embodiment of the system disclosed.

### DETAILED DESCRIPTION OF THE INVENTION

The method and system disclosed provide a relatively low cost and more flexible method and system to extract carbon dioxide from the flue gas of an oxy-coal combustion process than the traditionally proposed amine or cryogenic methods and systems. An oxy-combustion process is a combustion process in which nitrogen is largely eliminated from air before its use in combustion. The resulting nitrogen deficient air typically contains an oxygen concentration greater than approximately 80% (vol/vol), and more preferably greater than approximately 90% (vol/vol). An oxy-coal combustion process is an oxy-combustion process that produces heat from the combustion of coal with the nitrogen-deficient air. The nitrogen-deficient air may be diluted with carbon dioxide, such as from the flue gas, prior to combustion.

Increasing the CO₂ content of the flue gas by oxy-combustion of coal concentrates the flue gas sufficiently that membranes become attractive. Membrane processes can capture CO₂ from the flue gases of oxy-combustion of coal with similar compression energy expenditure as cryogenic processes. Additionally, by optimization of membrane surface area, flue gas compression requirements may be adjusted. Membrane processes can also provide CO₂ purity and CO₂ recovery combinations that may not be achievable with a cryogenic process. Additionally, membranes can tolerate greater amounts of water in the feed gas stream than cryogenic processes. As a result, membrane processes do not require an additional water removal process other than that mandated by the product gas specification. Membranes are also modular in nature and therefore their capacity is easily scalable to changes in feed flowrate. Thus, changes in the load produced by an oxy-coal combustion process can be easily accommodated by changing the number of membrane modules in operation.

Except for the removal of fly ash or other solid components, membranes do not require flue gas pretreatment in excess of any specified requirements for the final product. Thus, depending on the final CO₂ application, pretreatment costs may be avoided. For example, membrane materials may be selected that are resistant to SOₓ and NOₓ.

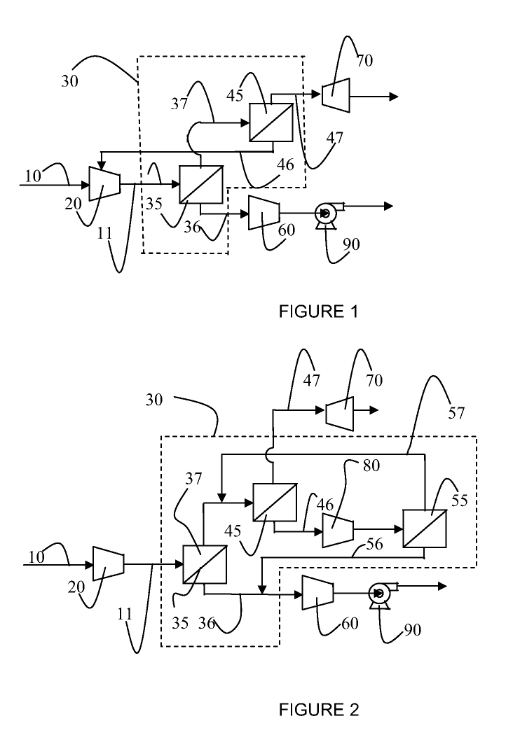

In the exemplary embodiments illustrated in FIGS. 1 & 2, the gaseous mixture 10 obtained from the flue gas of an oxy-coal combustion process is compressed by a first compressor train 20 from a low pressure range of approximately 0.8 to approximately 1.2 bars to a high pressure range of approximately 3 to approximately 30 bars. One of ordinary skill in the art will recognize that a compressor train includes one or more compressors depending upon the ultimate pressure increase desired for the gaseous mixture. If multiple compressors are used, heat exchangers may be located between the compressors to cool the compressed gas. Depending on multiple factors in the oxy-coal combustion process, the gaseous mixture 10 normally contains a carbon dioxide content of at least 65% (vol/vol dry basis). The carbon dioxide content of the gaseous mixture is also normally less than the concentration required by the carbon dioxide product, thereby necessitating purification. Preferably, fly ash and other solids that may be contained in the flue gas are removed from the gaseous mixture 10 by methods such as electrostatic precipitation prior to compression of the gaseous mixture 10 by the first compressor train 20.

Depending on the intended use of the carbon dioxide product, sulfur compounds, such as SO₂ and SO₃, contained in the flue gas may also be removed from the gaseous mixture 10 by methods such as flue gas de-sulfurization prior to compression by the first compressor train 20. However, it is also envisioned that SOₓ and NOₓ contained in the flue gas may be processed by the gas separation membrane unit 30. In that case, the SOₓ and NOₓ would preferably be sequestered with the CO₂ product.

From the first compressor train 20, the compressed gaseous mixture 11 flows into a gas separation membrane unit 30. In the embodiment illustrated in FIG. 1, the gas separation membrane unit 30 has two stages of membrane-based gas separation, 35 and 45. In the embodiment illustrated in FIG. 2, the gas separation membrane unit 30 has three stages of membrane-based gas separation, 35, 45, and 55. Each stage utilizes one or more gas separation membrane modules (not shown). Suitable gas separation membrane modules include any gas separation membranes known in the art that preferentially permeate carbon dioxide over nitrogen and oxygen. Non-limiting examples of such membranes include the membranes disclosed in U.S. Pat. Nos. 7,422,623 and 6,860,920, and 5,015,270, incorporated herein by reference in their entireties. One of ordinary skill in the art will recognize that the level of compression necessary to separate the gaseous mixture 10 may be decreased by increasing the surface area of the membranes, which may be accomplished by adding more membrane modules. Similarly, less surface area, and accordingly less or smaller membrane modules, may be required if the level of compression is increased.

Additionally one of ordinary skill in the art will recognize that the gas separation membrane unit 30 may utilize alternate membrane stage arrangements, provided the gas separation membrane unit 30 utilizes at least two stages of membrane-based gas separation. However, the embodiments depicted in FIGS. 1 & 2 are preferred embodiments for the disclosed method and system.

A drying step may be conducted before processing of the gaseous mixture 10 by the gas separation membrane unit 30 to remove water from the gaseous mixture 10. Alternatively, if the water content of the gaseous mixture 10 is tolerated by the gas separation membrane unit 30 but remains higher than the carbon dioxide product specification, the water vapor may be processed by the gas separation membrane unit 30 and collected with the first permeate 36. Removing the water vapor from the first permeate 36 in the product compression step should be cheaper due to the smaller size of the first permeate 36 and therefore of any drying equipment.

In FIG. 1, the first stage of membranes 35 separates the compressed gaseous mixture 11 into a first retentate 37 and a first permeate 36. The first permeate 36 is the carbon dioxide product of the gas separation membrane unit 30. The first stage 35 is operated to produce a first permeate 36 having a concentration of at least 90% (vol/vol dry basis), preferably 95% (vol/vol dry basis), and more preferably 97% (vol/vol dry basis). Based on this, the first stage 35 will recover less than 90% (vol/vol) of the CO₂ originally contained in the gaseous mixture 10. The first retentate 37 contains the additional CO₂ that is required to achieve the targeted recovery.

The second stage of membranes 45 separates the first retentate 37 into a second permeate 46 and a second retentate 47. The second retentate 47 contains less than approximately 10% (vol/vol) of the carbon dioxide originally contained in the gaseous mixture 10. Therefore, if this embodiment were utilized in conjunction with a coal power plant, the second retentate 47 may be vented to the atmosphere in compliance with current DOE definition of a clean coal power plant. To help recover energy from the disclosed method and system, an expander 70 may recover energy from expansion of the second retentate 47 to a lower pressure.

The second permeate 46 is recycled to the feed of the first stage of membranes 35 at the appropriate point in the first compressor train 20 depending on the pressure of the second permeate 46.

Preferably, after system start up, the first permeate 36 contains approximately 90% (vol/vol) to approximately 95% (vol/vol) of the carbon dioxide originally contained in the gaseous mixture 10 at a purity of approximately 90% (vol/vol dry basis) to approximately 97% (vol/vol dry basis). By changing the operating conditions of the process and the number of membrane modules in operation, other purity-recovery combinations can be achieved. Depending upon the intended use of the carbon dioxide product, the first permeate stream 36 may be further compressed to liquid form by third compressor train 60 and pumped to its intended destination by liquid pump 90.

In FIG. 2, the first stage of membranes 35 separates the compressed gaseous mixture 11 into a first retentate 37 and a first permeate 36. The first permeate 36 forms a portion of the carbon dioxide product. The first stage 35 is operated to produce a first permeate 36 having 90% (vol/vol dry basis), preferably 95% (vol/vol dry basis), and more preferably 97% (vol/vol dry basis) purity. Based on this, the first stage of membranes 35 will recover less than 90% (vol/vol) of the CO₂ originally contained in the gaseous mixture 10. The first retentate 37 contains the additional CO₂ that is required to achieve the targeted recovery.

The second stage of membranes 45 separates the first retentate 37 into a second permeate 46 and a second retentate 47. The second retentate 47 contains less than approximately 10% (vol/vol) of the carbon dioxide originally contained in the gaseous mixture 10. Therefore, if this embodiment were utilized in conjunction with a coal power plant, the second retentate 47 may be vented to the atmosphere in compliance with current DOE definition of a clean coal power plant. To help recover energy from the disclosed method and system, an expander 70 may recover energy from expansion of the second retentate 47 to a lower pressure.

In the embodiment depicted in FIG. 2, the second permeate 46 is compressed by the second compressor train 80. The third stage of membranes 55 then separates the compressed second permeate 46 into a third permeate 56 and a third retentate 57 rather than recycling the second permeate 46 back to the first stage of membranes 35 as shown in FIG. 1. The third permeate 56 and the first permeate 36 are combined to produce the carbon dioxide product. For some conditions, the embodiment of FIG. 2 will prevent dilution of the second permeate 46 by the lower purity gaseous mixture 10. Additionally, this embodiment may result in lower energy costs than the embodiment of FIG. 1. For example, the third stage of membranes 55 may require a lower feed pressure than required by the first stage of membranes 35 to provide the same purity carbon dioxide product, thereby reducing the compression energy requirements of the second compressor train 80. Alternatively, the third stage 55 may produce a third permeate 56 having a concentration greater than 95% (vol/vol dry basis). In that case, the first stage 35 may be configured to produce a first permeate 36 having a concentration less than 95% (vol/vol dry basis), so long as the combined first permeate 36 and third permeate 56 produce a carbon dioxide product having a concentration of 90% (vol/vol dry basis), preferably 95% (vol/vol dry basis), and more preferably 97% (vol/vol dry basis) and recover approximately 90% (vol/vol) to approximately 96% (vol/vol) of the carbon dioxide from the gaseous mixture 10. At lower purity, the first stage 35 will provide a greater recovery and hence push less of the gas stream to the subsequent stages where further compression is required, resulting in compression energy savings.

It will be understood that many additional changes in the details, materials, steps, and arrangement of parts, which have been herein described and illustrated in order to explain the nature of the invention, may be made by those skilled in the art within the principle and scope of the invention as expressed in the appended claims. Thus, the present invention is not intended to be limited to the specific embodiments in the examples given above and/or the attached drawings.

What is claimed is:

1. A method of purifying carbon dioxide from a gaseous mixture, said method comprising:
(a) obtaining a gaseous mixture from a flue gas of an oxy-coal combustion process at a low pressure, the gaseous mixture containing a percentage of carbon dioxide;
(b) compressing the gaseous mixture with a first compressor train; and
(c) flowing the compressed gaseous mixture into a gas separation membrane system having two or more stages of membrane-based gas separation, each stage selectively permeating a carbon dioxide enriched stream, the gas separation membrane system recovering approximately 90% (vol/vol) to approximately 95% (vol/vol) of the carbon dioxide in the gaseous mixture and producing a carbon dioxide product having a carbon dioxide concentration of approximately 90% (vol/vol dry basis) to approximately 97% (vol/vol dry basis).

2. The method of claim 1, wherein the low pressure of the gaseous mixture is approximately 0.8 to 1.2 bar.

3. The method of claim 1, wherein the gaseous mixture comprises greater than approximately 65% (vol/vol dry basis) carbon dioxide.

4. The method of claim 1, wherein the first compressor train compresses the gaseous mixture to approximately 3 to approximately 30 bar.

5. The method of claim 1, wherein the gas separation membrane system comprises two stages, wherein:
the compressed gaseous mixture flows into the first stage to produce a first retentate and the carbon dioxide product as a first permeate;
the first retentate flows into the second stage to produce a second permeate and a second retentate;
the second retentate is vented to atmosphere; and
the second permeate is directed to the first compressor train for combination with the gaseous mixture.

6. The method of claim 1, wherein:
the gas separation membrane system comprises three stages and a second compressor train;
the compressed gaseous mixture flows into the first stage to produce a first permeate and a first retentate;
the first retentate flows into the second stage to produce a second permeate and a second retentate;
the second retentate is vented to atmosphere and the second permeate flows into the second compressor train;
the compressed second permeate flows into the third stage to produce a third retentate and a third permeate;
the third retentate is combined with the first retentate at the second stage to produce the second permeate and the second retentate; and
the third permeate is combined with the first permeate to produce the carbon dioxide product.

7. A carbon dioxide purification system for recovering carbon dioxide from low pressure gaseous mixtures comprising:
a source of a gaseous mixture obtained from a flue gas of an oxy-coal combustion process, wherein the gaseous mixture contains greater than approximately 65% (vol/vol dry basis) carbon dioxide and is at a pressure of approximately 0.8 to 1.2 bar;
a first compressor train adapted to receive the gaseous mixture; and
a gas separation membrane unit adapted to receive the compressed gaseous mixture from the first compressor train, the gas separation membrane unit having two or more stages of membrane-based gas separation, each stage selectively permeating a carbon dioxide enriched stream, the gas separation membrane unit recovering approximately 90% (vol/vol) to approximately 95% (vol/vol) of the carbon dioxide in the gaseous mixture and producing a carbon dioxide product having a carbon dioxide concentration of approximately 90% (vol/vol dry basis) to approximately 97% (vol/vol dry basis).

8. The carbon dioxide purification system of claim 7, wherein the gas separation membrane unit comprises two stages, wherein:
the first stage is adapted to separate the compressed gaseous mixture into a first retentate and the carbon dioxide product as a first permeate,
the second stage is adapted to separate the first retentate into a second permeate and a second retentate,
the second stage has a retentate outlet in selective communication with ambient;
the second stage has a permeate outlet in fluid communication with the first compressor train; and
the first compressor train is further adapted to receive a combination of the gaseous mixture and the second stage permeate.

9. The carbon dioxide purification system of claim 7, further comprising a second compressor train, wherein
the gas separation membrane unit comprises three stages;
the first stage is adapted to separate the compressed gaseous mixture into a first permeate and a first retentate;
the second stage is adapted to separate the first retentate into a second permeate and a second retentate;
the second stage has a retentate outlet in selective fluid communication with ambient;
the second compressor train is adapted to receive the second permeate;
the third stage is adapted to separate the compressed second permeate into a third retentate and a third permeate;
the second stage has an inlet in fluid communication with a retentate outlet of the third stage for combination of the third retentate and the first retentate; and
a product line in fluid communication with a permeate outlet of the first stage and a permeate outlet of the third stage for combination of the third permeate and the first permeate to produce the carbon dioxide product.
